(19) United States
(12) Patent Application Publication
(10) Pub. No.: US 2015/0292998 A1
(43) Pub. Date: Oct. 15, 2015

(54) FREE DROP TESTER FOR ALLOWING A FREE FALL IMPACT TEST OF NUCLEAR FUEL PELLET AT ADJUSTABLE ANGLE

(71) Applicant: KEPCO NUCLEAR FUEL CO., LTD., Daejeon (KR)

(72) Inventors: Tae Sik JEONG, Daejeon (KR); Seung Jae Lee, Daejeon (KR); Yong Kyoon Mok, Daejeon (KR); Yoon Ho Kim, Daejeon (KR); Chung Yong Lee, Daejeon (KR); Yeon Soo Na, Daejeon (KR); Min Young Choi, Daejeon (KR); Dae Gyun Ko, Daejeon (KR); Jae Ik Kim, Daejeon (KR)

(73) Assignee: KEPCO NUCLEAR FUEL CO., LTD., Daejeon (KR)

(21) Appl. No.: 14/323,045

(22) Filed: Jul. 3, 2014

(30) Foreign Application Priority Data
Apr. 10, 2014 (KR) 10-2014-0042992

(51) Int. Cl. G01N 3/303

(52) U.S. Cl. CPC G01N 3/303

(57) ABSTRACT

Disclosed herein is a free drop tester wherein an angle of a test piece can be freely adjusted, a weight can fall on the exact spot, and an impulse of the weight can be controlled, and provides a free drop tester comprising a vertical guide disposed perpendicularly to the ground, a support body for supporting the vertical guide against the floor, a weight of which falling path is guided by the vertical guide, a test piece holder disposed under the bottom surface of the vertical guide, a horizontal rotation shaft of which one end is connected to a test piece holder, a power transmission unit connected to the other end of the horizontal rotation shaft, a test piece angle adjuster including a driving unit for supplying power to the power transmission unit, and a means for adjusting the height of the weight.

### BACKGROUND OF THE INVENTION

1. Technical Field

The present invention relates to an angle adjuster for a test piece and a free drop tester using it, particularly to an angle adjuster for a test piece enabling an angle for a test piece to be freely selected and a free drop tester using the same.

2. Description of the Related Art

Most nuclear power plants are divided mainly into pressurized light-water reactor type and heavy-water reactor type. And nuclear fuel assemblies comprising nuclear fuel bundles with a plurality of nuclear fuel pellets inserted in at the reactor core of all nuclear power plants generate heat energy by nuclear fission. The pellets comprising the nuclear fuel pellets are Uranium oxide UO₂, Gadolinium oxide Gd₂O₃, etc and SiC complex pellet for future nuclear fuel.

In manufacturing process, transportation, core loading and withdrawal, and nuclear fission, MPS (Missing Pellet Surface) is caused by partial destruction of surface by heat, and mechanical impact. In these processes, stress concentration in a cladding due to PCI (Pellet Cladding Interaction) is generated at a pellet piece detached from the surface of nuclear fuel pellet or the fracture surface so that deterioration of integrity of nuclear fuel assembly can lead to breakage.

Recently, operation condition of nuclear power plants requires nuclear fuel which is proper for high degree of burnup and long period in order to fuel cycle costs, and the situation is not tended to be overcome by common fuel pellet.

Also because of the accidents in nuclear power plants happened recently, fuel pellet's own structural integrity is required with multiple protection wall concept applied. Especially emission of nuclear fuel fission and PCI failure at output change are main factors threatening safety of core as well as nuclear fuel rod in high burn-up.

There has been vigorous research for pellet improving pellet-cladding breakage which is proper for high burn-up and extended cycle by improving properties of pellet by developing manufacturing variable until now. However, there is not any patent related to improvement of PCI properties by improving fuel pellet's own MPS resistance.

In order to improve properties of MPS-PCI, an impact test is necessarily required to consider all the factors which can cause MPS of fuel pellet which can occur under combustion in core of a nuclear power plant since manufacturing process. MPS behavior by application of dynamic load varies by surface shape as well as manufacturing variables such as size or density of grain.

Assuming manufacturing variables are the same, MPS resistance by external force depending on only the surface shape can be primarily evaluated by an impact test using simple mechanical mechanism.

In general, UO₂ pellet among nuclear fuel pellets comprises a chamfer, a land, and a dish and pellet manufacturers manufacture their own pellets which have different angle, length, and depth and shape of each part respectively.

AREVA, a French company developed MPS reduced PCI resistant pellet and reported improved impact resistance by shape improvement using self-produced impact test equipment.

Looking for the prior art related to a free drop tester for an impact test of nuclear fuel pellet, there is unexamined Patent Publication No. 10-2013-0077689, a free drop type impact testing device shown in FIG. 1.

The device above comprises a falling object 10, a gripper 20 securing the falling object, a conveying part 40 wherein the gripper is rotated or fixed, a line 50 mounted on the conveying part, a pulley 60 guiding the line, a fixing member 70 guiding the conveying part, a winch 80 winding up one side of the line.

According to the technique, a falling object can be easily replaced, conveyed and dropped by installing a gripper serving as the center of gravity. On the other hand, test accuracy is decreased because there is no falling guide means under the gripper to enable drop a falling object on the exact spot precisely. Also, MPS by external impact is not caused simply by vertical impact to a top and a lower side but by impact applied to every side of a pellet from various directions.

Accordingly, if a test piece is hit at a constant angle in the tester above, it is impossible to test impact from the various angles. And without means measuring the height of a weight, it will be required to prepare a plurality of falling weights in different weight.

There is another prior art unexamined Patent Publication No. 10-2007-0113491 titled by impact tester as shown in FIG. 2.

The impact tester 100 comprises a height-adjusting part 110 having at least more than three supports, a top plate 122 variously mountable on the top side of supports along supports according to a test height, an upper plate part 120 mounting on the top plate 122 and securing a spherical impactor and a flange 128 dropping an impactor, a guide plate 142 mountable on the center part of supports 112 variously along the supports 112 according to the size of a test piece S, a guide part 140 having a guide tube 148 mounting on a guide plate 142, and a base part 150 having a base plate 152 disposed on the lower side of the guide part 140 and securing a test piece on the top side which is hit by the impactor.

According to the technique above, the falling height of the impactor W can be easily adjusted by changing the position of the top plate 122 along the supports 112. But a test piece cannot be hit from various angles, can be hit from one direction only. The guide tube 148 serves mainly as preventing the impactor W from popping out after hitting a test piece S rather than guiding the impactor to the exact hitting point. Thus it can be disadvantageous that there is no means for hitting the exact position of a test piece by the impactor.

Thus, it is difficult to find a free drop tester which can hit the exact position of a test piece by a weight which can adjust strength level of impact from various angles.

### SUMMARY OF THE INVENTION

The present invention is for improving the prior art, and in particular relates to a free drop tester which can select an exact falling point of a weight, and adjust the level of impact, and also relates to test with impact applied to a test piece from various angles.

In order to accomplish the object above, the present invention provides a free drop tester comprising basically a vertical guide disposed perpendicularly to the ground, a support body for supporting the vertical guide against the floor, a weight of which falling path is guided by the vertical guide, a test piece holder disposed under the bottom surface of the vertical guide, a horizontal rotation shaft connected to a test piece holder, a power transmission unit connected to one end of the horizontal rotation shaft, a driving unit for supplying power to the power transmission unit, a test piece angle adjuster including the driving unit supplying power to the power transmission unit, a means for adjusting the height of the weight.

The power transmission unit used in a test piece angle adjuster comprises a first rotating body driven directly by the driving unit and a second rotating body driving the horizontal rotation shaft by being engaged to the first rotating body. And a diameter of a second rotating body is bigger than that of the first rotating body so that even a fine angle can be adjusted.

Then, an angle set in a test piece angle adjuster can be prevented from being twisted by letting the power transmission unit further comprise a stopper for stopping rotation of the first rotating body. And an angle gauge further shall be included in a test piece angle adjuster.

The vertical guide shall be preferably of a tube shape, a bore of the vertical guide shall be the same with allowable limits of error of falling point of the weight.

The support body for supporting the vertical guide against the floor comprises preferably a vertical bar, a horizontal bar fixedly linked to the upper side of the vertical bar.

The means for adjusting the height of the weight can comprise a wire member which is connected with the upper part of a weight and passes the horizontal bar and leads to the vertical bar, a roller which is disposed at the top of the horizontal bar to rotate and support a wire member, a height gauge installed in the vertical bar to measure vertical length of a wire member.

Unlike above, a means for adjusting the height of the weight can comprise a plurality of horizontal slits formed in the vertical guide, and a rigid plate which may be inserted into the slit so that impulse of the weight can be controlled by preventing the weight from falling by raising the weight up to the position of each slit and enabling the weight to fall by eliminating a rigid plate.

On the other hand, a test piece holder comprises preferably a plurality of blocks, and the plurality of blocks get together one another toward a test piece from different directions so that a test piece holder can grip a test piece in different sizes with stable force.

Here, the plurality of blocks comprises a rear block connected to the horizontal rotation shaft, a front block facing to the rear block, and a lower block connected to the lower sides of the rear block and the front block, wherein the rear block and the front block have grooves formed in a shape of the ends of the test piece, and the bottom surface of a test piece is seated on the lower block and the test piece holder may be rotated and supported by the front block and the lower block.

And further, finish treatment for friction reduction and graphite coating shall be done preferably on the inner side of the vertical guide so that occurrence of an error of the impulse by friction with the inner side of the vertical guide can be minimized as a weight falls.

A free drop tester according to the present invention has the following advantages.

First, a weight can be fallen to an exact point of a test piece so that a test can be performed with a very small error.

Secondly, a height of free fall of a weight can be adjusted freely; thereby the impulse can be controlled more easily than preparing a plurality of weights of different weight.

Thirdly, adjustment of an angle of a test piece is enabled so that an impact test can be operated in all direction according to properties of a test piece.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a front view of a free fall type impact tester according to the prior art;

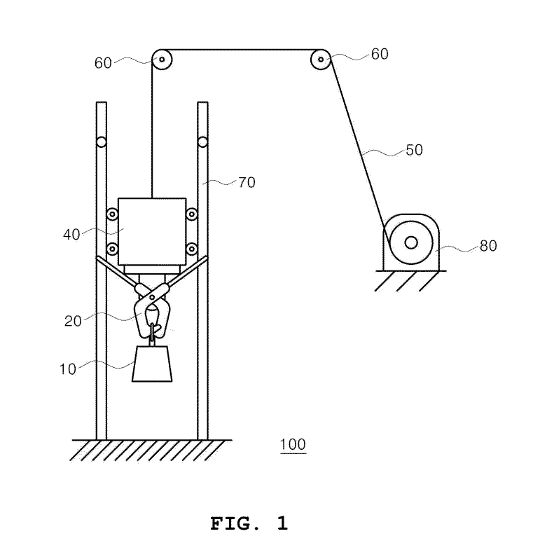

FIG. 2 is a perspective view of an impact tester for automobile parts according to the prior art;

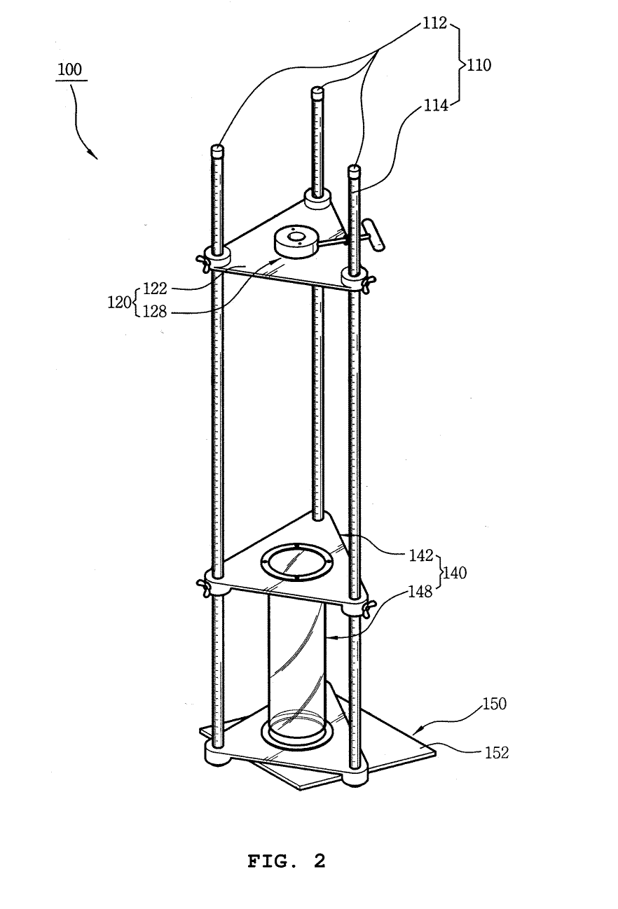

FIG. 3 is a perspective view showing an exemplary embodiment of a free drop tester according to the present invention;

FIG. 4 is a perspective view showing a test piece angle adjuster of a free drop tester according to the present invention;

FIG. 5 is a perspective view showing a roller and a wire member as means for adjusting a height of a weight of a free drop tester according to the present invention;

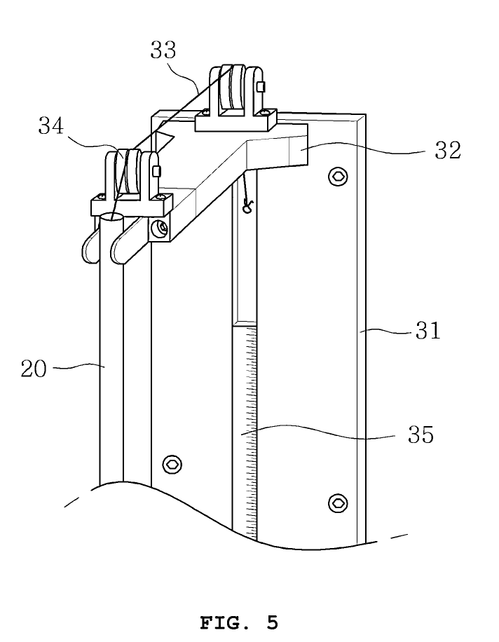

FIG. 6 is a perspective view showing a rigid plate and a horizontal slit formed in a vertical guide which is means for adjusting a height of a free drop tester according to the present invention;

FIG. 7 is a perspective view showing a test piece holder of a free drop tester according to the present invention and a variable operation of a test piece holder by a test piece angle adjuster together with FIG. 8;

FIG. 8 is a perspective view showing a test piece holder of a free drop tester according to the present invention and a variable operation of a test piece holder by a test piece angle adjuster together with FIG. 7;

FIG. 9 is a photo showing a test piece angle adjuster of a free drop tester according the present invention;

FIG. 10 is a photo showing a falling point of a weight at a test piece holder of a free drop tester according to the present invention;

FIG. 11 is a photo showing a test piece gripped by a test piece holder of a free drop tester according to the present invention.

### DESCRIPTION OF THE PREFERRED EMBODIMENTS

Hereinafter, a detailed description will be given of the present invention.

A free drop tester and a test piece angle adjuster used for a free drop tester according to the present invention are described with reference to the accompanying drawings.

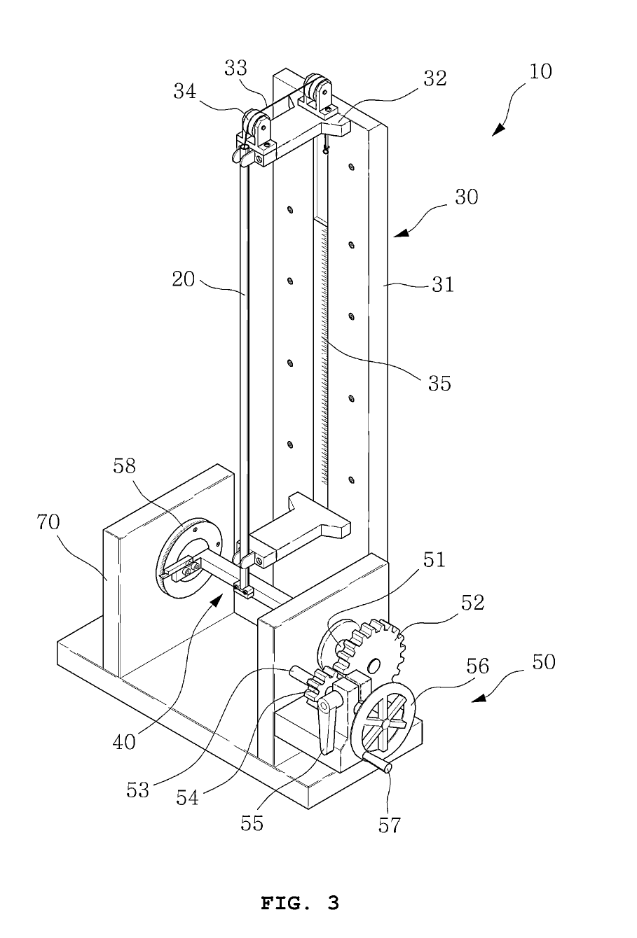

First, the overall structure of the present invention is described briefly with reference to FIG. 3 mainly, and each constitutional element is described specifically in reference to the remaining drawings.

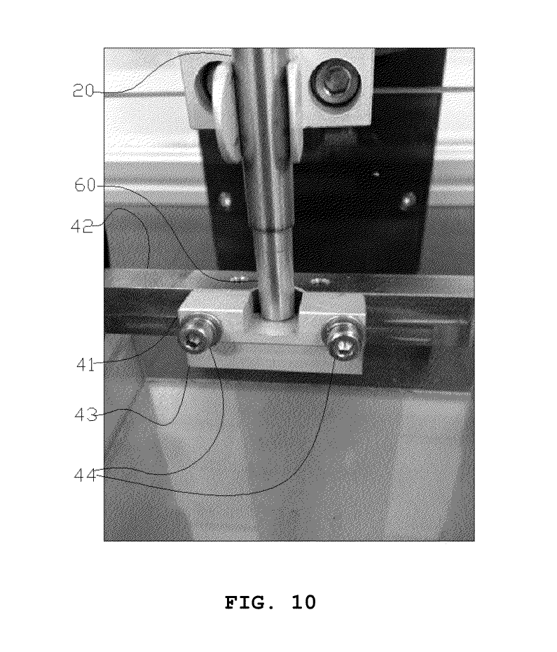

Referring to FIG. 3 and FIG. 10, a free drop tester 10 comprises a vertical guide 20 disposed perpendicularly to the ground, a support body 30 supporting a vertical guide 20 against the ground, a weight 60 of which falling path is guided by the vertical guide 20, a test piece holder 40 disposed under the bottom side of the vertical guide 20, a test piece angle adjuster 50 connected to the test piece holder 40, and a means 25, 33, 34, 35 for adjusting height of the weight 60.

The test piece angle adjuster 50 comprises a horizontal rotation shaft 51, a power transmission unit 52, 53, 54 connected to one end of the horizontal rotation shaft 51 and a driving unit 56, 57 supplying power to the power transmission unit 52, 53, 54.

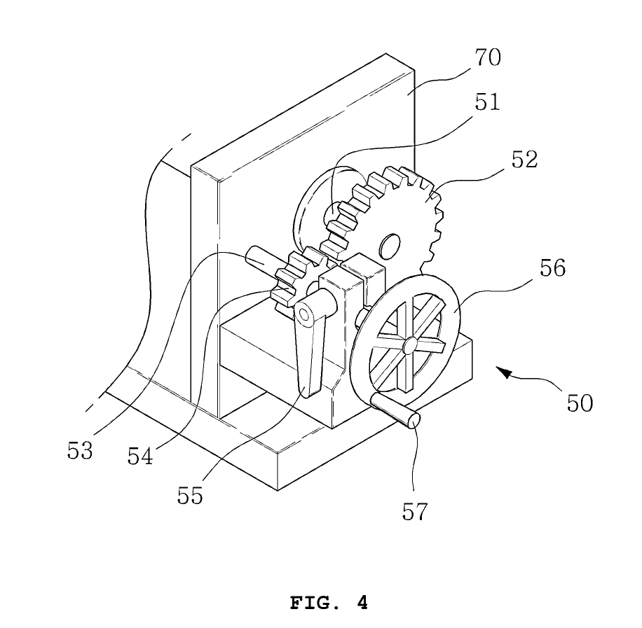

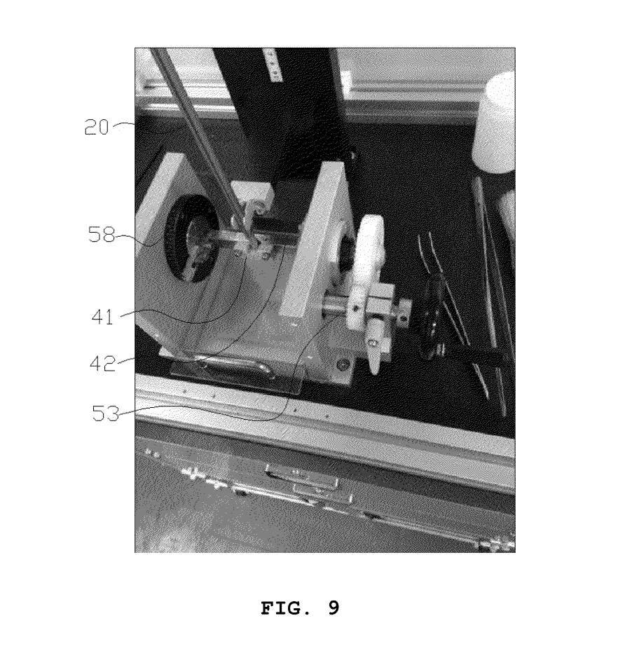

Referring to FIG. 4 and FIG. 9, a power transmission unit 52, 53, 54 comprises a first rotating body 54 driven directly by a driving unit 56, 57, a second rotating body 52 driving a horizontal rotation shaft 51 by coupling to the first rotating body 54. The horizontal rotation shaft 51 is fixedly connected to the center of rotation plane of a second rotation shaft 52 and is rotated together when a second rotation shaft 52 is rotated. Power from a driving unit 56, 57 is transmitted to a first rotation unit 54 by a rotation shaft of the first rotating body 53 in order to interlock the driving unit 56, 57 and the first rotating body 54 in movement.

An exemplary embodiment of FIG. 3 shows a driving unit 56, 57 comprises a handle 56 and a knob 57 to be driven by a human hand. However, it can be also driven by a power device such as a motor and an extra power source except for manual operation.

And a test piece angle adjuster 50 can include an angle gauge 58. In an exemplary embodiment of FIG. 3, a horizontal rotation shaft 51 is connected to both sides of a test piece holder 40, a power transmission unit 52, 53, 54 is connected to one end of the horizontal rotation shaft 51, and an angle gauge 58 is attached to the other end of the horizontal shaft 51. But an angle gauge 58 can be disposed at other positions besides to the position shown in FIG. 3 as long as a rotation angle of a test piece can be measured.

Also, preferably a test piece angle adjuster 50 can be further equipped with a stopper 55 for stopping rotation of rotation shaft 53 of a first rotating body 54 in a power transmission unit 52, 53, 54. In FIG. 4, a stopper 55 is configured to stop the rotation of a rotation shaft of a first rotating body and comprises two clamping jaws enabling to firmly grip or release a rotation shaft 53 of a first rotating body, and a knob to grip or release. However, other means for stopping rotation can be chosen besides to the means shown in FIG. 4.

A vertical guide 20 in a free drop tester 10 is of a tube shape in an exemplary embodiment of FIG. 3. The shape of a vertical guide 20 is not restricted as long as a vertical movement of a weight 60 can be guided. Accordingly, the shape of a vertical guide can be more than three vertical sticks standing around falling trace of a weight, or one or more than one rigid wire embracing around falling trace in a spiral shape.

A vertical guide 20 serves for guiding a weight 60 so that a weight 60 can be guided precisely to a falling point. Thus, a vertical guide 20 cannot serve for guiding a weight in case the inner circumference surface of horizontal cross-section is much bigger than the outer circumference surface of horizontal cross-section of a weight 60. However, in case the inner circumference surface of horizontal cross-section is minutely bigger than the outer circumference surface of horizontal cross-section of a weight 60, the surface of a weight 60 is contacted frequently with the inner surface of a vertical guide 20 and impulse of impact applied to a test piece 1 from a weight 60 is different from the calculated amount based on free fall because of friction force. Thus, preferably the bore of the vertical guide 20 shall be the same with allowable limit of error of falling point of the weight.

Then, the inner surface of a vertical guide 20 which is directly contacted by the outer surface of a weight 60 shall be processed with treatment preferably and coated with graphite in order to minimize friction between the outer surface of a weight and the inner surface of a vertical guide. Graphite coating corresponds to amorphous carbon film equivalent to diamond bond, and it is adequate for surface coating film for sliding parts because of its superior abrasion resistance and low coefficient of friction.

In an exemplary embodiment of FIG. 3, a support body 30 supports a vertical guide 20 against the floor. The support body 30 comprises a vertical bar 31 and a horizontal bar 32. A vertical guide is supported by a horizontal bar 32 which is supported by being connected to the upper end of the vertical bar 32.

Adjusting height of a weight 60 can be in two ways.

In a first way, as shown in FIG. 3 two rollers 34 are installed in a vertical bar 32 of a support body 30 and a wire member 33 is connected to the top of a weight 60. And the wire member 33 goes through two rollers 34 installed in the horizontal bar 32 from the top of a weight 60 to a height gauge 35 attached vertically to a vertical bar 31. Two rollers 34 serve for rotating and supporting the wire member 30. Thus, the height is adjusted by pulling a wire member 33 along a height gauge 35 attached to a vertical bar 31 up to the point where the target impulse can be acquired.

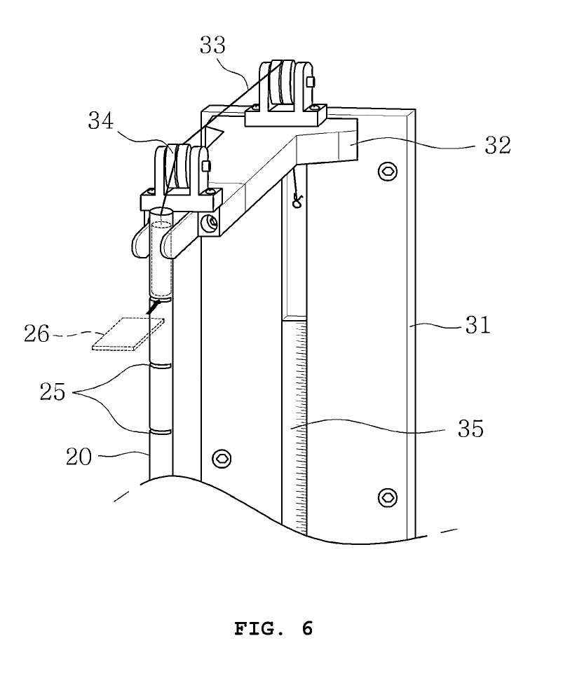

In a second way, as shown in an exemplary embodiment of FIG. 6, a plurality of horizontal slits 25 are formed parallel in vertical direction along a vertical guide 20 and the bottom surface of a weight 60 is placed on the same horizontal level with a horizontal slit 25 of the height where the target impulse can be obtained, and a rigid plate is plugged in the horizontal slit 25 to prevent a weight 60 from falling. And, the rigid plate 26 is plugged out when a weight 60 is needed to fall.

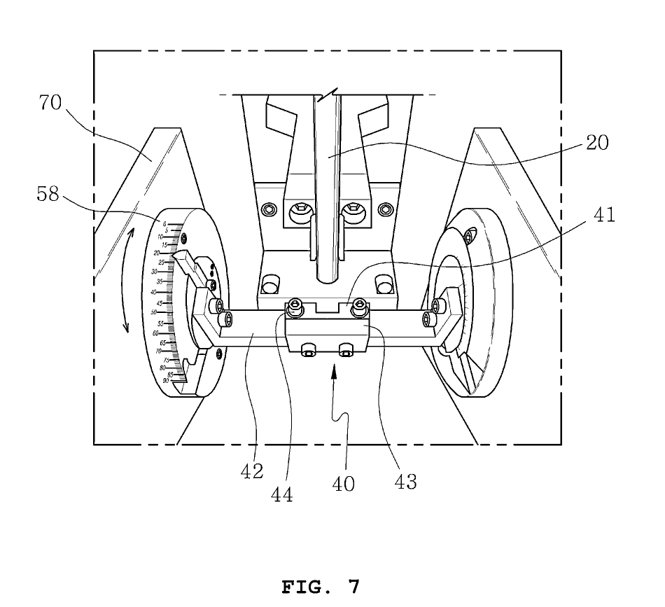

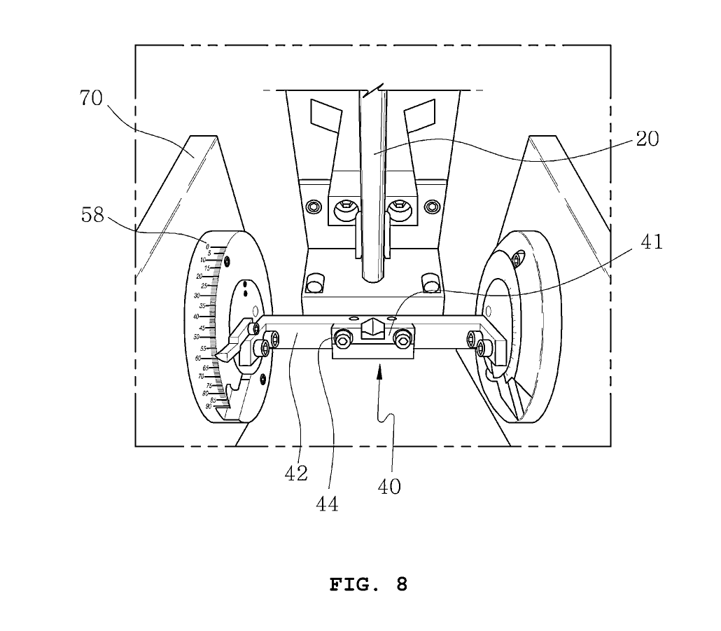

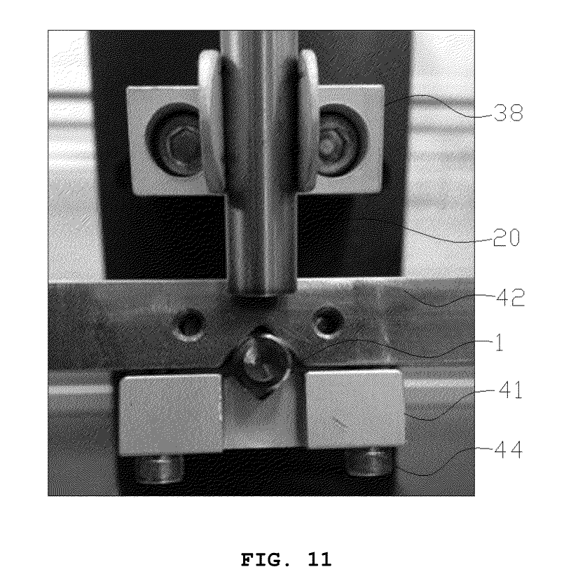

A test piece holder 40 is varied by a test piece angle adjuster 50 as shown in FIG. 7 and FIG. 8. FIG. 7 and FIG. 8 show the varying state in two drawings. In reference with FIG. 7, FIG. 8, FIG. 10, and FIG. 11, a test piece holder 40 is described as follows.

There can be various ways how a test piece 1 is supported by a test piece holder 40. In an exemplary embodiment of FIG. 3, a test piece holder 40 is made of a plurality of blocks, and those blocks are configured to get together toward a test piece from different directions to grip a test piece.

In an exemplary embodiment of FIG. 7, the plurality of blocks comprises a front block 41, a rear block 42, and a lower block 43. A test piece holder 40 shall be able to rotate so that a test piece 1 can be tested with impulse from different angles. Thus a test piece holder is rotated and supported by a test piece adjuster 50. In an exemplary embodiment of FIG. 3, a rear block 42 is connected to a horizontal rotation shaft 51 of a test piece angle adjuster 50 to support the whole test piece holder 40. However, the block supported by a horizontal rotation shaft 51 can be a front block 41 or a lower block 43, thus it can be randomly chosen which block is connected to a horizontal rotation shaft 51.

The distance between a front block 41 and a rear block 42 is adjusted by a block screw 44 and if tightening the block screw, the distance between the front block and the rear block is closed by tightening the block screw so that a test piece disposed between the front block 41 and a rear block 42 can be gripped and if loosening the block screw, a test piece is released as the distance is increased. The bottom surface of a test piece 1 is seated on the upper surface of the lower block 43.

A test piece angle adjuster 50 preferably can include an extra vertical side wall 70 so that a test piece angle adjuster 50 can be supported against the floor. Two vertical sidewalls 70 shall be built in the way they have a test piece holder between them and face each other. And it is preferably desirable that the vertical sidewalls are built perpendicular to a horizontal rotation shaft 51 in order that they all can be passed through by the horizontal rotation shaft 51.

Hereinafter, it is described how respective constitutional elements are operated to one another in the procedure of a free fall impact test of a test piece by the free drop tester 10 described above.

First, a test piece 1 shall be located between blocks of a test piece holder 40 and gripped by tightening a block screw 44 to interlock a test piece between blocks.

An angle of a test piece shall be adjusted according to an angle gauge 58 and fixed by using a stopper 55 in order that a weight can impact on the adequate spot of a test piece.

After an angle of a test piece 1 is adjusted, a height of a weight 1 is adjusted by the means for adjusting the height of a weight. There are two exemplary embodiments for the means for adjusting the height as described earlier.

First embodiment introduces the method using a wire member 33, rollers 34 for rotating and supporting the wire member 33, a height gauge for measuring falling length of wire member in order that the top of the weight can be connected to the wire member 33 and pulled up to the required height and released to be dropped. The wire member 33 is supported by the rollers 34 and the wire member can be moved as the rollers 34 are rotated. And the wire member goes through the rollers 34 to a height gauge 35 which is attached perpendicularly to a vertical bar 31. Thus if the wire member is dropped along the height gauge 35, on the contrary the weight 60 is raised up to the required height. And if the wire member 33 is released, the weight 60 shall fall free.

Second embodiment introduces the method using a plurality of horizontal slits 25 formed vertically along the body of a vertical guide 20. A means for raising a weight 30 can be also a wire member 33. The weight 60 is raised up to the target height and the bottom surface of a weight 60 is placed on the same horizontal level with a horizontal slit 25, and a rigid plate 26 equipped with a horizontal slit 25 is plugged in the horizontal slit 25 to prevent a weight 60 from falling.

And when the rigid plate 26 is removed, the weight shall fall free.

Accordingly, an impact test can be practiced for a precisely required spot of a test piece from an accurate angle.

With reference to an exemplary embodiment of FIG. 4 when an angle of a test piece 1 is adjusted after a test piece is gripped, a diameter of a first rotating body 54 adjusted by rotating a knob 57 is smaller than a diameter of a second rotating body 52. Thus a rotation angle of a second rotating body 2 which is rotated by interlocking with a first rotating body is smaller than a rotation angle a rotation angle while rotating a knob 57 and more precise angle adjustment is enabled.

A gripped test piece 1 is adjusted to be tested by a test piece adjuster 50 as shown in FIG. 7 and FIG. 8. A test piece 1 itself is not illustrated in FIG. 7 and FIG. 8, but FIG. 7 and FIG. 8 show how a test piece holder 40 can be varied by a test piece angle adjuster 50 in order to show how an angle of a test piece 1 can be adjusted with itself gripped by a test piece holder 40.

Precise adjustment of angle can be acknowledged by an angle gauge 58. It can be ready for an impact test of a test piece.

As described above, the present invention is not limited by the embodiments and the accompanying drawings. Possible for a large number of changes and modifications to the category of the technical idea disclosed in the present invention without departing from the present invention to those skilled in the art will be able to understand better. Appropriate, all such changes and modifications and equivalents as fall within the scope of the invention, therefore, can be considered.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A free drop tester comprising:
a vertical guide disposed perpendicularly to the ground;
a support body for supporting a vertical guide against the ground;
a weight of which falling path is guided by the vertical guide;
a test piece holder disposed under the bottom surface of the vertical guide;
a test piece angle adjuster including a horizontal rotation shaft of which one end is connected to a test piece holder, a power transmission unit connected to the other end of the horizontal rotation shaft, and a driving unit for supplying power to the power transmission unit; and
a means for adjusting the height of the weight.

2. The free drop tester of claim 1, wherein the power transmission unit comprises a first rotating body directly driven by the driving unit, and a second rotating body driving the horizontal rotation shaft by being engaged to the first rotating body, in which a diameter of the second rotating body is bigger than that of the first rotating body.

3. The free drop tester of claim 2, wherein the power transmission unit further comprises a stopper for stopping rotation of the first rotating body.

4. The free drop tester of claim 3, wherein the test piece angle adjuster further comprises an angle gauge.

5. The free drop tester of claim 1, wherein the vertical guide is of a tube shape, and the bore of the vertical guide is the same with the boundary of falling area with allowable limit of error of falling point of the weight.

6. The free drop tester of claim 1, wherein the support body comprises a vertical bar, a horizontal bar fixedly linked to the upper side of the vertical bar, and a means for adjusting the height of a weight comprises a wire member which is connected with the upper part of the weight and passes the horizontal bar and leads to the vertical bar, a roller disposed at the top of the horizontal bar to rotate and support the wire member, and a height gauge installed in the vertical bar to measure vertical length of the wire member installed in the vertical bar.

7. The free drop tester of claim 1, wherein the means for adjusting the height of a weight comprise a plurality of horizontal slits formed in the vertical guide and a rigid plate which may be inserted into the slit.

8. The free drop tester of claim 1, wherein the test piece holder comprises a plurality of blocks and the plurality of blocks get together toward a test piece from different directions in order to grip a test piece.

9. The free drop tester of claim 8, wherein the plurality of blocks comprises a rear block, a front block facing the rear block, and a lower block connected to the lower sides of the rear block and the front block, wherein the rear block and the front block have grooves formed in a shape of the ends of the test piece, and the bottom surface of a test piece is seated on the lower block, and the horizontal rotation shaft connected to any of the rear block, the front block, and the lower block may rotate and support the test piece holder.

10. The free drop tester of claim 5, wherein the inner surface of the vertical guide is processed for friction reduction and coated with graphite.

11. A test piece angle adjuster comprising:
a horizontal rotation shaft connected to a test piece holder of a free drop tester;
a power transmission unit connected to one end of the horizontal rotation shaft;
a driving unit connected to the power transmission unit to supply power; an angle gauge for measuring rotation angle of the horizontal rotation shaft; and
a stopper for stopping the power transmission of the power transmission unit.

12. A test piece angle adjuster of claim 11, wherein the power transmission unit comprises a first rotating body driven directly by the driving unit, and a second rotating body driving the horizontal rotation shaft by engaging to the first rotating body, in which a diameter of the second rotating body is bigger than a diameter of the first rotating body.
